(19) United States
(12) Patent Application Publication
(10) Pub. No.: US 2006/0229770 A1
(43) Pub. Date: Oct. 12, 2006

(54) MOVEABLE CONTROLS FOR VEHICULAR APPLICATIONS

(75) Inventor: Russell W. Strong, Craftsbury Common, VT (US)

Correspondence Address: ARTZ & ARTZ, P.C., 28333 TELEGRAPH RD., SUITE 250, SOUTHFIELD, MI, 48034, US

(73) Assignee: Integrated Vision, Inc., Craftsbury Common, VT (US)

(21) Appl. No.: 11/279,477

(22) Filed: Apr. 12, 2006

Related U.S. Application Data
(60) Provisional application No. 60/670,579, filed on Apr. 12, 2005.

(51) Int. Cl. G06F 17/00

(52) U.S. Cl. 701/1; 701/49

(57) ABSTRACT

A vehicle control system (14) for a frontal ingress and egress vehicle (10) includes one or more vehicle hand control modules (12). Each hand control module (12) includes a housing (20) that is multi-dimensionally position adjustable and has a stowed position and a deployed position. The housing (20) is clear of an entering area (56) of a vehicle control seat (30) or seats when in the stowed position for frontal ingress and egress by a vehicle operator. The housing (20) is in a fixed position forward of the vehicle operator or operators when in the deployed position, the vehicle operator being in a seated position. Multiple adjustment devices (146) are coupled to the housing (20) for mobility control of the vehicle (10).

### CROSS-REFERENCE TO RELATED APPLICATION

The present invention claims priority from U.S. Provisional Application No. 60/670,579, filed on Apr. 12, 2005, entitled “Moveable Controls For Vehicle Or Application.”

### TECHNICAL FIELD

The present invention relates to vehicle mobility and non-mobility systems and controls. More particularly, the present invention is related to the operation, configuration, placement, and overall adjustability of vehicle hand operated controls of a vehicle.

### BACKGROUND

Various frontal ingress and egress vehicles currently exist and are primarily used for utility type applications, such as in landscaping and construction, or for individuals that have disabilities or walking impairments. Some of the stated vehicles include commercial riding lawn mowers, skidsteers, or electrically powered wheelchairs. Other personal mobility type vehicles are currently being developed for personal transportation.

The stated vehicles often have one or more control handles that are positioned forward and to the side of the vehicle operator and at hand level. Primary control handles are typically in the form of a bar that has a fixed single operating location. The handles are used for controlling the direction and speed of the vehicles. In operation, one pushes the handles forward or pulls the handles back to control forward, reverse, and in relative action, turning mobility of the vehicles. Although some of the handles are able to be tilted laterally outward when the vehicle is not in use, the handles and associated bars typically extend outward and significantly outside the envelope of the vehicle body, which for a limited width vehicle, can increase clearances of the vehicle and difficulty in storage and manipulation of the vehicle when not in use. On vehicles where a hand grip control can rotate into place, its location is determined by a fixed position lever. As such, existing controls do not satisfy current and future criteria for ease and flexibility in control positioning.

Some of the stated vehicles have drop down safety restraint bars or the like to provide additional safety over that provided by, for example, a seat belt. The drop-down-bars wrap around the operator seat and generally have an associated lateral axis that is rearward of the vehicle occupant upon which they rotate. The drop-down-bars may extend laterally and fully across the vehicle operator and are used solely as a safety restraint and/or as an armrest.

It has become desirable that a vehicle operator have a wide open and easily accessible vehicle control station for ingress and egress purposes. It is also desirable that the controls for a vehicle, including vehicle system controls, other than those associated directly with fore, aft, and turning movements, be located forward of the vehicle occupant for improved ergonomics, are configured to provide a stable operating experience with a good perception of security, and are out of general view and removed from in front of the vehicle operator when the vehicle is stopped and the controls are fully stowed. Thus, there exists a need for an improved vehicle control system that overcomes the limitations and disadvantages associated with conventional control and safety bars.

### SUMMARY OF INVENTION

One embodiment of the present invention provides a vehicle control system for a frontal ingress and egress vehicle. The system includes a vehicle hand control module. The module has a housing that is multi-dimensionally position adjustable and has a stowed position and a deployed position. The housing is clear of an entering area of a vehicle control seat when in the stowed position for frontal ingress and egress by a vehicle operator. The housing is in a fixed position forward of the vehicle operator when in the deployed position, the vehicle operator in a seated position. Adjustment devices are coupled to the housing for control of the vehicle mobility. The controls may also or as an alternative be used for other non-mobility control features.

The embodiments of the present invention provide several advantages. One such advantage provided by one embodiment of the present invention, is the provision of hand control modules that are multi-dimensionally adjustable and versatile for improved ergonomics of a frontal ingress/egress vehicle. The stated advantage along with the ability to extend and to adjust the hand control modules in fore and aft directions provides for the accommodation of multiple passengers in a tandem seated arrangement or the like. The stated embodiment also allows for forward placement of controls that they do not disrupt a vehicle operator field-of-view of an environment when stowed or deployed. When stowed the controls provide an increased open view of the environment. The stated controls allow the vehicle operator to feel more within the vehicle when the controls are deployed, as opposed to when stowed.

Another advantage provided by another embodiment of the present invention, is the inclusion of hand controls that are forward of a vehicle occupant, that extend laterally across the vehicle occupant, and that are configured and of a size that provides a safety restraint for the vehicle occupant. Due to the size and placement of the controls, the controls serve to retain the vehicle occupant within the vehicle and are also perceived by the vehicle occupant as providing the same.

Yet another advantage provided by another embodiment of the present invention, is the inclusion of hand controls that are position adjustable such that they are clear of the entering area of a frontal entry operator seat. In one related embodiment, the hand controls laterally rotate outward up to approximately 180° from a deployed state to provide a wide-open vehicle control station for enjoyment of the environment without any controls in general view or line-of-sight. The wide-open station can also aid in ease of ingress and egress of the vehicle. The rotational outward adjustability provides an area that is, generally, wider than the vehicle operator seat and yet does not or minimally increases the overall envelope of the vehicle.

The present invention itself, together with the stated and other attendant advantages, will be best understood by reference to the following detailed description, taken in conjunction with the accompanying figures.

### BRIEF DESCRIPTION OF THE DRAWINGS

For a more complete understanding of this invention reference should now be made to the embodiments illustrated in greater detail in the accompanying figures and described below by way of examples of the invention wherein:

FIG. 1 is a front view of a frontal ingress and egress open top vehicle incorporating multi-dimensionally position adjustable hand control modules in a semi-stowed state and in accordance with an embodiment of the present invention;

FIG. 2 is a front view of the vehicle of FIG. 1 illustrating a vehicle operator in a seated position and the hand control modules in a deployed state;

FIG. 3 is a top view of the vehicle of FIG. 1 illustrating a vehicle operator in a seated position and the hand control modules in a deployed state;

FIG. 4 is a side view of a frontal ingress and egress partially enclosed vehicle incorporating multi-dimensionally position adjustable hand control modules in a deployed state in accordance with another embodiment of the present invention;

FIG. 5 is a perspective view of a vehicle body structure, which may be incorporated in the vehicles of FIG. 1 or 4 in accordance with another embodiment of the present invention;

FIG. 6 is a front view of a frontal ingress and egress vehicle illustrating hand control module lateral stowed position adjustability in accordance with an embodiment of the present invention;

FIG. 7 is a front view of a frontal ingress and egress vehicle configured for wheelchair reception and vehicle operator seat use thereof that has multi-dimensionally position adjustable hand control modules in accordance with another embodiment of the present invention;

FIG. 8 is a close-up perspective view of left and right multi-dimensionally position adjustable hand control modules in accordance with an embodiment of the present invention;

FIG. 9 is a side close-up view of the position adjustable elements associated with a multi-dimensionally position adjustable hand control module in accordance with an embodiment of the present invention;

FIG. 10 is a block diagrammatic view of a vehicle hand control system in accordance with an embodiment of the present invention; and

FIG. 11 is a logic diagram illustrating a method of controlling a frontal ingress and egress vehicle in accordance with an embodiment of the present invention.

### DETAILED DESCRIPTION

In the following figures the same reference numerals will be used to refer to the same components. While the present invention is described with respect to hand controls for an open frontal ingress/egress vehicle, the present invention may be adapted and applied to various vehicles, systems, and applications. The present invention may be applied in utility and/or mobility usage applications, automotive applications, aeronautical applications, nautical applications, or other applications where such modules would be beneficial. The present invention may be applied on personal transportation vehicles, military vehicles, turf care vehicles, agricultural vehicles, construction vehicles, and utility and delivery vehicles. The present invention may also be used in a variety of other applications, such as on video game stations, driving and/or flight training simulators, or on other applications where multi-dimensionally adjustable hand controls and/or a folding in of a console or control modules after ingress is desired. The present invention may be applied to non-vehicle applications. Also, a variety of other embodiments are contemplated having different combinations of the below described features of the present invention, having features other than those described herein, or even lacking one or more of those features. As such, it is understood that the invention can be carried out in various other suitable modes.

In the following description, various operating parameters and components are described for one constructed embodiment. These specific parameters and components are included as examples and are not meant to be limiting.

Also, in the following description the term “barless” is used in the context of and refers to multi-dimensionally adjustable hand control modules that are not simply and do not contain bars or hand bars, often utilized in the mobility control of a frontal ingress/egress vehicle. A hand control module that has a fixed position when deployed and contains a throttle that rotates on its longitudinal axis is not considered a “bar”. However, a hand control that is in the form of a rod that may be pushed or pulled to direct or accelerate a vehicle is considered a “bar”. Such bar controls are often found on riding lawnmowers or other utility type vehicles.

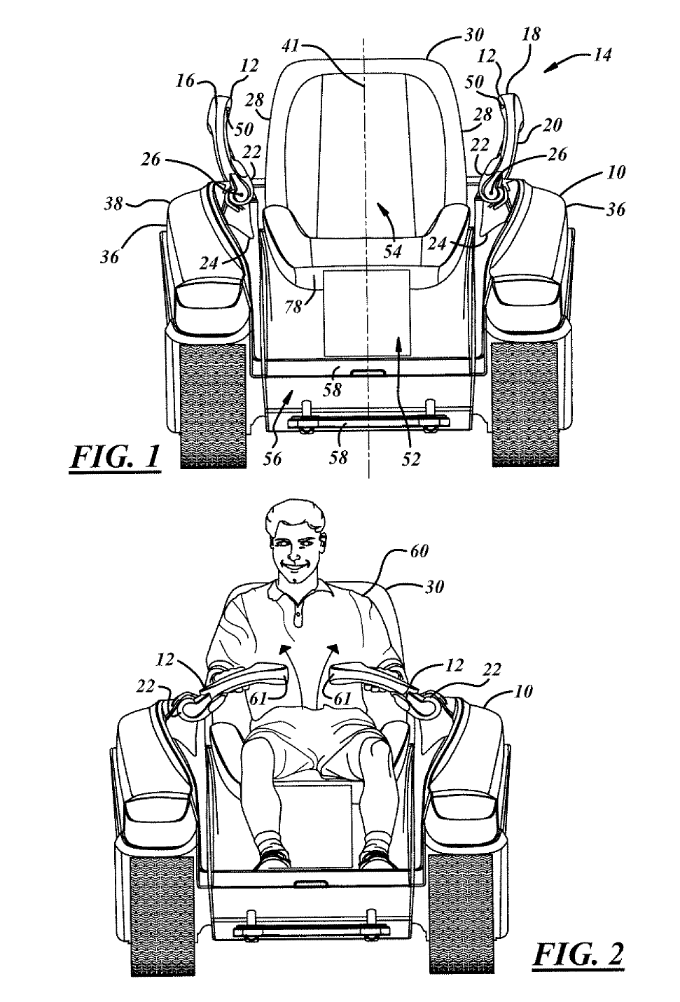

Referring now to FIG. 1, a front view of a frontal ingress and egress open top vehicle 10 incorporating multi-dimensionally position adjustable hand control modules 12 in a semi-stowed state and in accordance with an embodiment of the present invention is shown. The vehicle 10, as well as other vehicles shown and described in FIGS. 2-7 may be considered personal mobility usage vehicles. A personal mobility usage vehicle, generally, refers to a vehicle that is occupied and operated by a single individual. A personal mobility usage vehicle may have one or more passenger seats in addition to the vehicle operator. The seats may be in a tandem arrangement or in some other layout or arrangement known in the art.

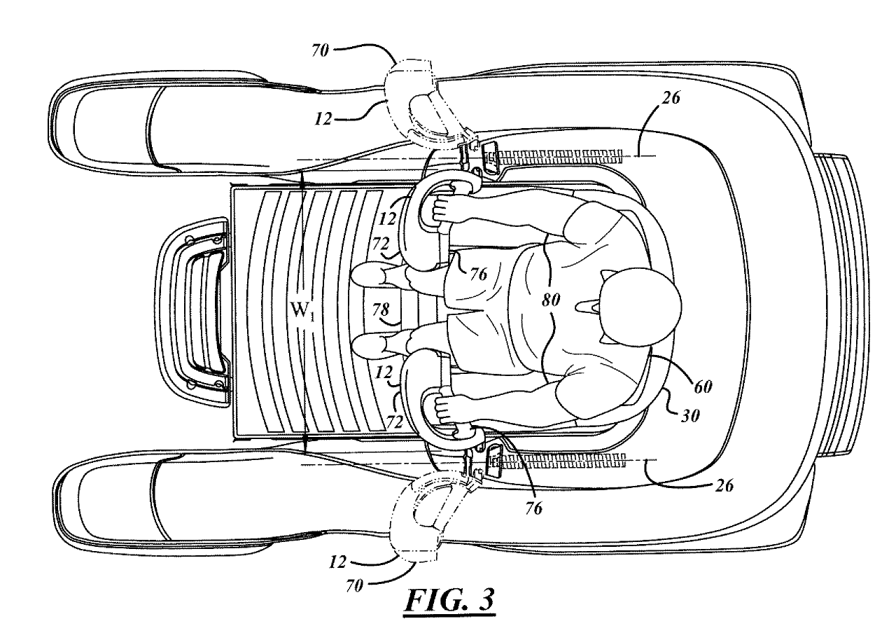

The vehicle 10 includes a moveable control system 14 (only a portion of which is shown in FIG. 1), which has a right control module 16 and a left control module 18. Although two control modules are shown, any number of which may be incorporated. Each of the control modules 12 has a housing 20 with a base 22 that is rotated on base housing 24 and about a generally fore/aft longitudinal pivot axes 26. The housings 20 are located proximate the associated right and left sides 28 of the vehicle operator seat 30. Right and left handles may be incorporated into the hand control modules 12 and may be used to control the vehicle, which are best seen in FIGS. 3-5 and 8. The base housing 24 are mounted to the vehicle structure or vehicle structural member (not shown) in the side panels 36 of the vehicle body structure 38.

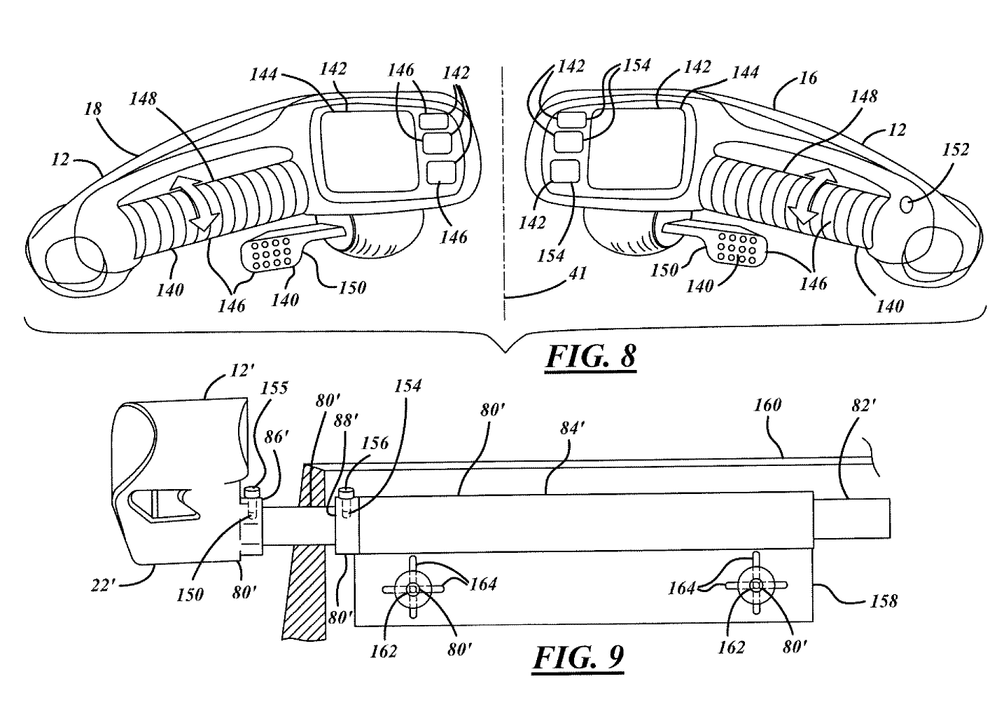

The hand control modules 12 are adjustable in three dimensions. The lateral adjustability is shown and described with respect to FIGS. 1-9. The longitudinal adjustability is shown and described with respect to FIGS. 3, 5, and 9. The vertical adjustability is shown and described with respect to FIG. 9. The position adjustability of hand control modules 12 allows the vehicle system controls and operator indicative or information devices to be placed within a desirable range for operators of varying size. Such controls and devices are shown in FIG. 8. This also provides the ability to achieve comfortable ease of use during operation of the vehicle 10 or when there is a passenger in tandem behind the operator.

In FIG. 1, the hand control modules 12 are positioned in a partially stowed position. The hand control modules 12 have a partially stowed state, a fully stowed stated, and a deployed state. The partially stowed state refers to when the hand control modules 12 are laterally rotated outward approximately 90° from a fully deployed state or position and away from the longitudinal vehicle centerline 41. A deployed position refers to generally a position forward of the seat 30, whereby the hand control modules 12 are rotated inward toward the centerline 41 and extend across the front of the seat 30, as shown in FIGS. 2-4. A fully deployed state may refer to when the hand control modules are rotated inward and are oriented approximately horizontally forward of and over the lap of a vehicle operator. The fully stowed state refers to when the hand control modules 12 are rotated laterally outward approximately 180° from the fully deployed position. The hand control modules 12 may be positioned, fixed, and locked at any point in their rotation. The partially stowed and fully stowed positions may refer to non-operational positions. The hand control modules 12 may be operative or inoperative when stowed or deployed. An activation switch 50 or the like may be incorporated to activate the hand control modules 12. During ingress or egress by an operator the hand control modules 12 are rotated laterally outward to provide a frontal entry path that is open to the seat 30 without interference of restraint systems or controls.

In the partially stowed position, the hand control modules 12 are rotated clear of the seat and provide a path 52 for entry and exit of an operator into and out of an operation position within the vehicle 10. The control system 14 may be locked when in any position to prevent accidental activation of any devices controlled by the hand control modules 12.

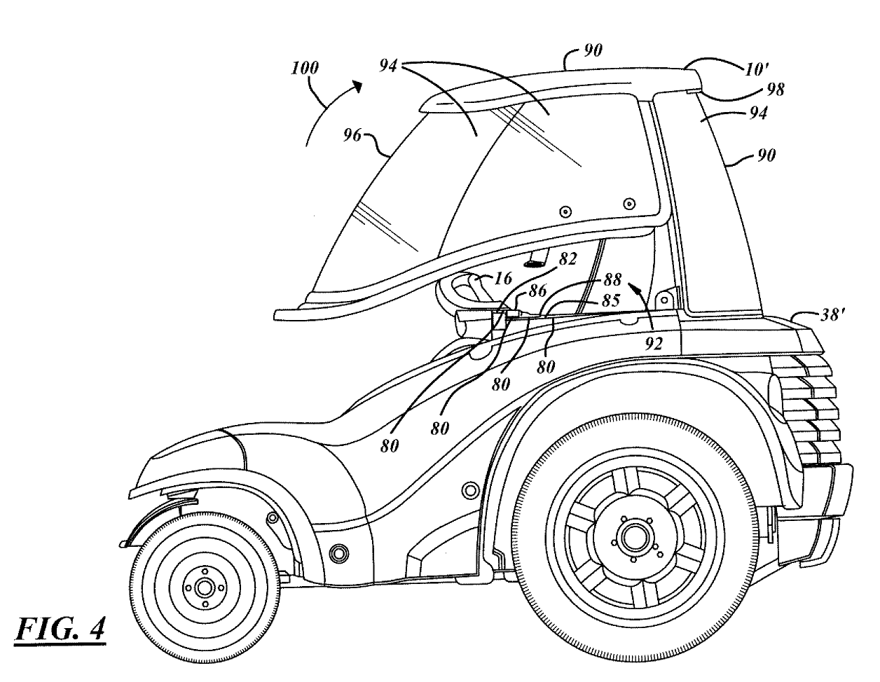

In the embodiment shown, the vehicle 10 has the body structure 38 with various panels and a vehicle operator control station 54. The vehicle 10 does not have a roof, ingress/egress doors, and is open such that the control station 54 is not enclosed and is easily accessible. Although not shown, the vehicle 10 may have an opening roof and front door. The control station 54 refers to the area of the vehicle that has the vehicle operator seat 30 and the hand control modules 12. A vehicle operator enters the vehicle 10 through a frontal entering area 56 by stepping on front steps 58 and then sitting in the seat 30. Once in the seat 30, the vehicle operator rotates the hand control modules 12 inward and over the lap of the operator. The hand control modules 12 may have preset locations such that the operator need only rotate the hand control modules 12 inward, as opposed to adjusting the position thereof in multiple dimensions for each time of use. The multi-dimensional adjustments or adjustable elements are best seen in FIGS. 4 and 9.

The vehicle 10 may have one or more passenger seats or an extendable portion of seat 30 (not shown). The hand control modules 12 in being multi-dimensionally position adjustable allow for the locating thereof in a position that provides additional room for a passenger or rider. In one embodiment, the seat 30 is used as a passenger seat and a flip-up seat or extending portion of seat 30 (not shown) is incorporated forward of the seat 30 and is used as the vehicle operator seat. In the stated embodiment, the hand control modules 12 are extended to a position forward of the seat 30 and along side of the flip-up seat.

The hand control modules 12 may be incorporated in both an open or closed vehicle operator station. A partially closed station is shown in FIG. 4. The hand control modules 12 also allow for placement of vehicle controls generally out of view of a vehicle operator when in an open environment or seating configuration and/or when the vehicle 10 is stationary or mobile.

Referring now to FIG. 2, a front view of the vehicle 10 is shown illustrating a vehicle operator 60 in a seated position and the hand control modules 12 in a deployed state. Note that this is only one sample deployed state for one specific sample embodiment. The position of the hand control modules 12 for the deployed state may vary depending upon the vehicle, the size of the operator, the personal preferences of the operator, the seat position, or other factors known in the art. The hand control modules 12 when in the deployed state may also be operative or inoperative.

A rotational path of the hand control handles 12 is shown, as indicated by numerical designators. The hand control modules 12 may be positioned significantly out of the general operational line-of-sight of the operator 60 when deployed, whether the vehicle 10 is stationary or in operation. In other words, the hand control modules 12 may be at a position forward of the operator 60 and low enough in position relative to the operator 60 as not to interfere with the ability of the operator to see the surrounding environment for operation of the vehicle, yet tilted in the direction of the occupant head and/or high enough to monitor controls and displays thereof.

The hand control modules 12 when deployed create a buffer zone and serve as a vehicle occupant restraint to retain the vehicle occupant 60 in the vehicle 10. When secured in the deployed state the hand control modules 12 also create a general feel of a console in front of the operator 60, creating a barrier and giving a measure of safety to the operator 60 either alone or when used in concert with a seat belt or other restraint. The angle of deployment and the relative position of the hand control modules 12 alter the restraint effect associated therewith. Adjusting the angle of deployment may also alter the area of the occupant body that is restrained, such as during a collision or a decelerating incident. In a vehicle 10, such as that shown, that has a frontal open configuration in that it may not have a closing front door, windshield, or other forward structural restraint for the vehicle operator, the hand control modules 12 provide a restraint with some structure and size. The hand control modules 12 provide additional protection over that and in addition to the use of a seat belt. The vehicle operator also perceives a safer operating environment when in the vehicle 10, over other frontal ingress/egress vehicles without such modules, due to the size of the hand control modules 12 and the location thereof forward of the operator 60.

In addition to being rotated vertically, the hand control modules 12 may be configured to rotate horizontally in fore and aft directions. When deployed the bases 22 may be fixed and mounted on pivots (not shown) and the inner portions 61 of the hand control modules 12 may be pushed or pulled in fore and aft directions, respectively. The fore and aft movement of the inner portions 61 may correspond to heading direction, speed change, and/or steering control of the vehicle 10.

Referring now to FIG. 3, a top view of the vehicle 10 is shown illustrating a vehicle operator 60 in a seated position and the hand control modules 12 in a deployed state. This view shows the adjustment of the movable controls along the fore/aft axis. The hand control modules 12 are shown in a stowed state, as designated by dashed lines 70, and in a deployed state, as designated by solid lines 72.

The hand control modules, as shown have handles 76. In the deployed state, the overall width W1 of the handles 76 is generally in the comfort zone of the operator on the seat bottom cushion 78 of the seat 30. This allows the arms 80 of the operator 60 to extend forward naturally to reach the handles 76.

The longitudinal adjustment of the hand control modules 12 accommodates for operators of various sizes and for tandem seat and occupant vehicle configurations. The fore/aft axes 26 are shown upon which the hand control modules 12 not only rotate, but may also be extended in a forward direction or retracted in a rearward direction. The fore and aft adjustability provides ergonomic and operator comfort. This is described in further detail below with respect to FIG. 9.

Referring now to FIG. 4, a side view of a frontal ingress and egress partially enclosed vehicle 10′ incorporating multi-dimensionally position adjustable hand control modules 12 in a deployed state and in accordance with another embodiment of the present invention is shown. The vehicle 10′ may be referred to as a personal transportation vehicle. The vehicle 10′ may be modified for utility applications, such as for lawn care, construction, mail delivery, or other applications or service purposes.

The hand control modules 12 include the position adjustable elements 80, some of which are shown in FIG. 4. The hand control modules 12 include a longitudinally adjustable sliding member 82, a slide mount 84, a rotational locking device 86, and a slide-locking device 88. The hand control modules 12 are rotationally attached to the sliding member 82 and secured rotationally in position by the rotational locking device 86. The sliding member 82 is attached to the slide mount 84 and secured longitudinally in position by the slide-locking device 88. The slide mount 84 is fixed to a vehicle structural member (not shown), such as a frame and may be vertically and/or horizontally position adjustable. The embodiment of FIG. 9 illustrates vertical adjustability of the slide mount 84.

The hand control modules 12 may be positioned for entry and exit and yet still remain within a zone defined by a fixed or closing section of an environmental enclosure 90 of the operator area 92. The vehicle 10′ has the upper enclosure 90 attached to the body structure 38′. The enclosure 90 may have multiple windows 94 including a windshield 96 and covers a substantial portion of the vehicle 10′. The enclosure 90 may be pivotably mounted to, removable from, or integrally formed as part of the body structure 38′. The enclosure 90 may have windows and/or doors that open and close. The enclosure may be mounted on hinges 98, which allow it to pivot and open rearward, as represented by arrow 100. The enclosure 90 provides a shielding effect relative to the environment, yet readily allows ingress and egress.

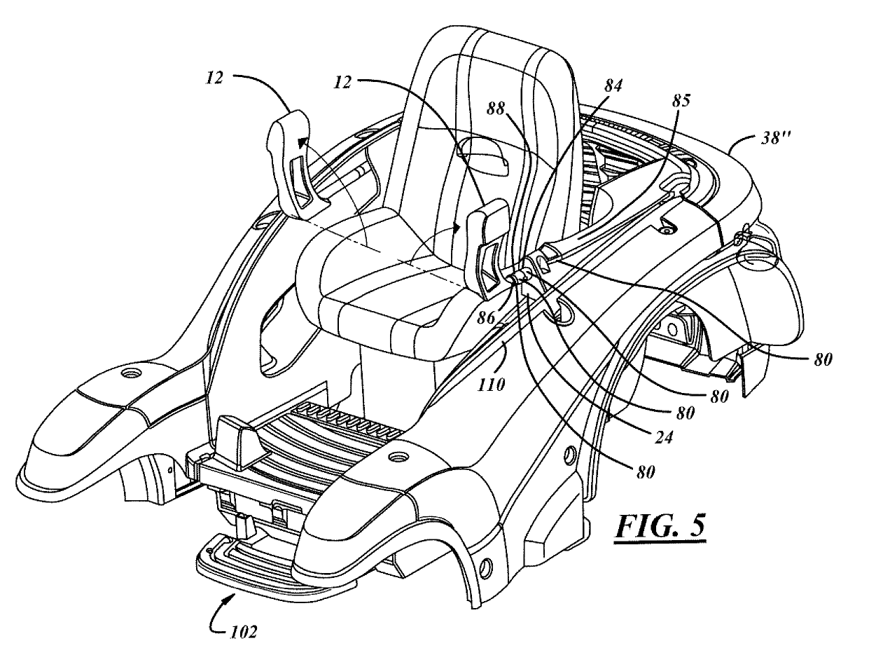

Referring now to FIG. 5, a perspective view of a vehicle body structure 38″, which may be incorporated in the vehicles 10 and 10′, is shown in accordance with another embodiment of the present invention. This view illustrates the feature of movable hand control modules 12 providing a frontal path of entry and exit 102 to and from the associated vehicle by an operator. The hand control modules 12 are generally rotationally positioned in or out for entry, exit, and utilization when the vehicle is at rest or in motion. Longitudinal and rotational adjustments 80 are shown. The slide mounts 84 are attached to the base housing 24, which are coupled to the frame 110.

The hand control modules 12 may be locked in position and locked in an activated or deactivated state, such that control of the associated vehicle may be locked to prevent accidental activation of the vehicle or a vehicle system thereon. The hand control modules 12 are attached to the adjustable sliding members 86 and secured rotationally in position by the rotational locking devices 82 (only one is shown). The adjustable sliding members 86 are attached to the base housing 24 and secured longitudinally in position by the slide locking devices 82 (only one is shown). The covers 85 of the base housing 24 may be used as armrests for an operator.

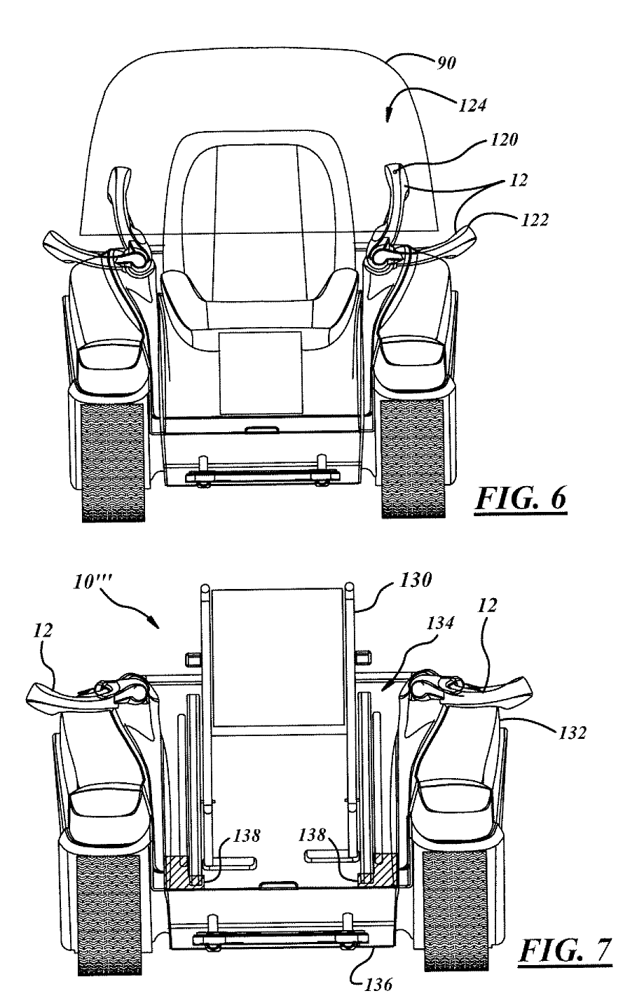

Referring now to FIG. 6, front view of a frontal ingress and egress vehicle 10″ illustrating hand control module lateral position adjustability in accordance with an embodiment of the present invention is shown. The vehicle 10″ has an environmental enclosure 90′. The hand control modules 12 may be rotated to a partial stowed state 120, which is within the zone 124 of the enclosure 90′, or to a fully stowed state 122 that is external to the zone 124. The enclosure 90′ may be lifted, opened, or be configured to allow the rotation of the hand control modules 12 to the fully stowed position. The fully stowed position provides a full field of vision for an operator when the vehicle is at rest. As an example of use, the hand control modules 12 may be fully rotated outward in a non-operational state when the environmental enclosure is open, for use by an operator utilizing the vehicle 10″ at rest.

Referring now to FIG. 7, a front view of a frontal ingress and egress vehicle 10′″ configured for wheelchair reception and vehicle operator seat use thereof that has the multi-dimensionally position adjustable hand control modules 12 in accordance with another embodiment of the present invention is shown. The vehicle 10′″ may be configured for various types of wheelchairs and the like. The adjustability of the hand control modules 12 allows for the introduction or incorporation of a wheelchair 130 into the vehicle 10′″, which is a personal transportation vehicle similar to that described above. The vehicle may also be equipped with electronic wire or wireless communication devices (not shown) for communication with electronics on the wheelchair.

The vehicle 10′″ includes a body structure 132 that has an open inner area 134. The vehicle 10′″ does not include a seat. The vehicle 10′″, however, includes a lift system (not shown) or a deployable ramp 136 for allowing the ingress and egress of the wheelchair 130 in an open state. The vehicle 10′″ may also include one of a number of devices for wheelchair locks 138. The vehicle operator sitting in the wheel chair 130 deploys the lift system or the ramp 136, for entry into the vehicle 10′″. The wheelchair 130 once locked in place on the vehicle 10′″ serves as the vehicle operator seat. For a further detailed description of a lift system see U.S. patent application Ser. No. 10/154,021, entitled “A Lift Mechanism for a Seating Device”, which is incorporated herein by reference.

Referring now to FIG. 8, close-up perspective view of the left and right multi-dimensionally position adjustable hand control modules 12 is shown in accordance with an embodiment of the present invention. The hand control modules 12 are shown as viewed by a vehicle operator. The hand control modules 12 include several mobility controls 140 and non-mobility controls 142 that serve various functions. The mobility controls 140, in general, refer to controls for accelerating or steering the vehicle. The non-mobility controls 142 refer, in general, to other vehicle system controls, such as entertainment system controls, navigation system controls, lighting system controls, indicator system controls, object or pedestrian system controls, heat or air-conditioning controls, or other controls known in the art. The controls 140 and 142 may be considered vehicle system controls and may have operator indicative or information devices. Note that for driving and flight simulation applications and for video game stations, the controls 140 and 142 may be considered simulation task performing instruments.

The hand control modules 12 may include displays 144 and several adjustment devices 146. The displays 144 may be in the form of indicators, monitors, touch screens, or other displays known in the art. The displays 144 when in the form of touch screens may also be considered as adjustment devices. The adjustment devices 146 may include rotational controls 148, thumb levers 150, a plug-in control port 152, and button controls 154. The adjustable controls may also include joystick controls (not shown) mounted on the hand control modules 12. The stated adjustment devices 146 are provided as one example, other adjustment devices known in the art may be used. The hand control modules 12 may be programmed to select one or more of the multiple control functions for operator input. The controls 140 and 142 may be locked in an inactive state when in the non-operational mode to prevent accidental activation.

The rotational controls 148 may be in the form of throttle controls, vehicle heading controls, gear controls, transmission controls, wheel drive controls, brake controls, or in some other form known in the art. The thumb levers 150 may be used for signaling, braking, throttle control, lighting control, or for other purposes known in the art. The displays 144 and the button controls 154 may be used as audio controls, video controls, entertainment controls, signal indicator controls, global positioning system controls, navigation system controls, or as other controls known in the art.

The hand control modules 12 and the controls 140 and 142 thereof may be in communication with other devices on a vehicle via wired, wireless, cable, hydraulic, pneumatic, or mechanical communication. The positioning and pivoting of the hand control modules 12 and the communication therewith allows for continuous communication to the vehicle as desired, regardless of position and orientation. Such variability also provides simple maintenance of the communication devices.

The plug-in control port 152 is such that a non-standard plug-in control can be docked to the hand control modules 12 to receive input from personal devices such as portable radios, personal data assistants (PDAs), computers, cellular phones, or other personal electronic devices. The controls 140 and 142 may be used in concert with other controls, such as foot controls (not shown) or other controls that are not located on the hand control modules 12. The operator may select for control of the vehicle via the left hand control module 18, the right hand control module 16, or a combination thereof.

Referring now to FIG. 9, a side close-up view of the position adjustable elements 80′ associated with a multi-dimensionally position adjustable hand control module 12′ in accordance with an embodiment of the present invention is shown. The hand control module 12′ has at least three degrees of freedom. The hand control module 12′ is attached to the sliding member 82′, which slides within the slide mount 84′. The hand control module 12′ may be locked rotationally in place using the rotational locking device 86′ or a device in concord with lock 156. The sliding member 82′ may have grooves 150 in which a first locking pin 155 may be inserted to prevent rotation of the hand control module 12′ or fore and aft movement of the sliding member 82′. The first pin 155 may be spring loaded to default within one of the grooves 150. Of course, a variety of other locking devices may be used.

The sliding member 82′ may also be locked longitudinally via the slide locking device 88′. The slide locking device 88′ is configured similarly as the rotational locking device 86′. Grooves or slots 154 may be formed in the sliding member 82′ in which a second locking pin 156 may be inserted. The slide mount 84′ is attached to a plate 158 that is mechanically coupled to the vehicle frame 160 by front and rear vertically and longitudinally variable mounts 162. These mounts 162 may be in the form of bolts or other known mounts. The vertical mounts 162 extend within slots 164 in the plate 158, and slots 159 on the vehicle frame 160, which allow for fore and aft and vertical position adjustment and angulation of the plate 158 and thus the hand control module 12′ and the slide mount 84′.

The position adjustable elements 80′ may be adjusted in a vehicle operator control station. The hand control module 12′ and the position adjustable elements 80′ may be moved and operated via electrical, mechanical, cable, hydraulic, or pneumatic known control techniques or a combination thereof.

It will be understood by those of ordinary skill in the art that the base 22′ of the hand control module 12′ may be designed for variable positioning in locations up and down and laterally in and out, relative to a vehicle. It will be further understood by those of ordinary skill in the art that the base 22′ may be designed for variable positioning by means of a pivot, linkages, a slide, a universal type mount, or a combination thereof.

It will be further understood by those of ordinary skill in the art that the base 22′ may be mounted to and/or relative to a seat, and to the frame of a vehicle, such as a frame surrounding a vehicle operator control station.

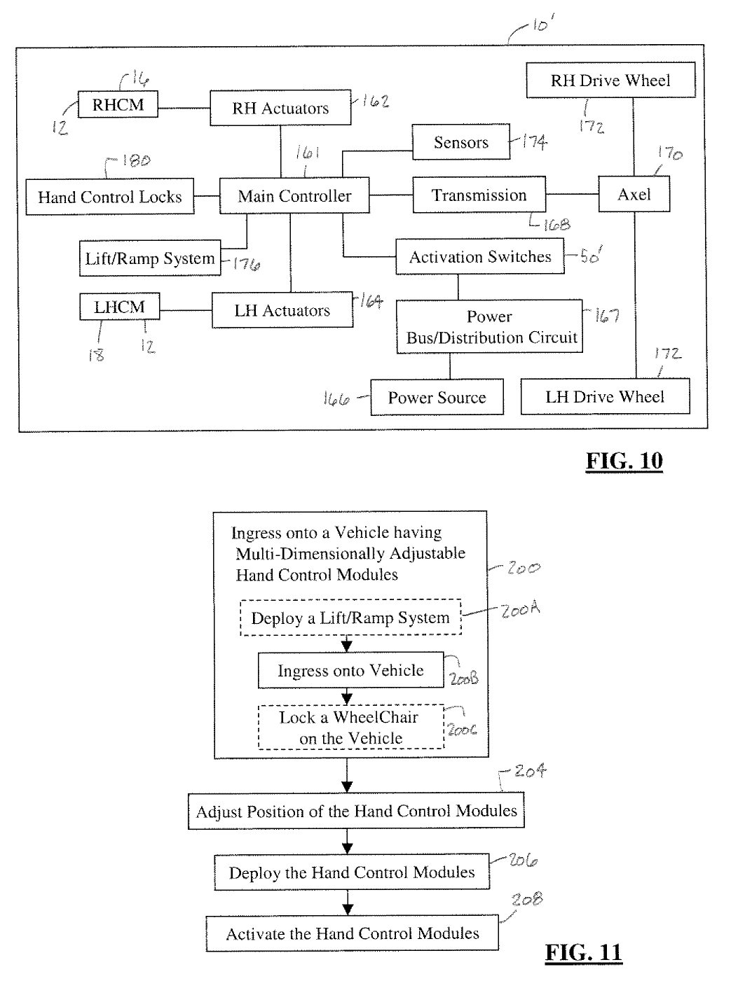

Referring now to FIG. 10, a block diagrammatic view of a vehicle hand control system 14′ of a vehicle 10^{IV} in accordance with an embodiment of the present invention is shown. The control system 14′ includes the hand control modules 12, which are coupled to a main controller 161. Right hand actuators 162 and left hand actuators 164 may be coupled between the right hand module 16 and the left hand module 18, respectively. The actuators 162 and 164 may be electrically, mechanically, pneumatically, or hydraulically configured for movement of the hand control modules 12. The main controller 161 receives power from a power source 166, such as a motor or battery, via a power bus/distribution circuit 167. Activation switches 50′ may be coupled between the power distribution circuit 167 and the controller 161, between the power source 166 and the power distribution circuit 167, between the hand control modules 12 and the controller 161, or elsewhere as envisioned by one skilled in the art. The main controller may provide power to a transmission 168 or the like and/or to an axle 170 for driving of the wheels 172.

The controller 161 may be microprocessor based such as a computer having a central processing unit, memory (RAM and/or ROM), and associated input and output buses. The controller 161 may be an application-specific integrated circuit or may be formed of other logic devices known in the art. The controller 161 may be a portion of a central vehicle main control unit, an interactive vehicle dynamics module, a restraints control module, a main safety controller, a control circuit having a power supply, combined into a single integrated controller, or may be a stand-alone controller as shown.

The control system 14′ may also include sensors 174 and a lift/ramp system 176, such as that described above. The sensors 174 may be used to detect objects, temperature, location of the vehicle, tire pressure, vehicle speed, power remaining in the power source 166, or various other vehicle related parameters. The information detected by the sensors 174 may be indicated on the hand control modules 12 and used by the controller 161 and hand control modules in performing various vehicle related tasks. The hand control modules 12 may also each include controllers similar to the main controller 161, depending upon the application and complexity of the hand control modules 12.

The control system 14′ may also include hand control module locks 180 that are electronically activated, which may replace the locks 86 and 88, described above. The module locks 180 are coupled to the hand control modules 12 and to the controller 161. The operator of the vehicle 10^{IV} or the controller 161 may activate or deactivate the module locks 180.

Referring now to FIG. 11, a logic diagram illustrating a method of controlling a frontal ingress and egress vehicle in accordance with an embodiment of the present invention is shown. Although the following steps are described with respect to primarily the embodiments of FIGS. 1-10, they may be easily modified for other embodiments of the present invention.

In step 200, the vehicle operator ingresses into or onto the vehicle, such as one of the vehicles 10′, 10″, or 10′″. The vehicle is in a parked and deactivated state and the hand control modules 12 are in a stowed state during ingress of the vehicle operator. In step 200A, the operator may deploy a lift or ramp system, such as the ramp 136 or the system 176. In step 200B, the operator ingresses onto the vehicle. In step 200C, the operator may lock a wheelchair on the vehicle using wheelchair locks, such as locks 138.

In step 202, the operator may adjust the hand control modules 12 using the adjustable elements 80 and/or actuators 162 and 164, as described above. This adjustment may be performed on the vehicle or off the vehicle.

In step 204, the operator deploys the hand control modules 12. The hand control modules are released and allowed to rotate. The hand control modules 12 are rotated inward to an ergonomically comfortable and occupant preferred position forward of the vehicle operator. Rotation of the hand control modules 12 into a deployed mode may utilize sensors 174 to secure lock of wheelchairs or other devices.

In step 206, the hand control modules 12 are activated. In step 208, the vehicle is driven using the hand control modules 12.

The above-described steps are meant to be illustrative examples; the steps may be performed sequentially, synchronously, simultaneously, or in a different order depending upon the application. The above-stated process may be performed in reverse when deactivating and egressing from the vehicle.

The present invention satisfies various vehicle applications where special considerations for placement of hand controls is desired, as well as a variety of ergonomic interests relative to a vehicle operator is a concern. A vehicle that is used for outdoors enjoyment, for example, or other events, where the operator would desire maximum forward and side vision, would be aided by controls and restraint systems that have variable positioning and are removable from the line-of-sight of the operator when the vehicle is in or not in operation. The present invention satisfies this desire. The present invention provides hand controls that are easy to move into, and out of, operating position by operators of all ages and levels of ability. The hand controls are easily adjustable to accommodate fore-aft position for ergonomic reasons, for comfort of different size operators and passenger accommodation.

While the invention has been described in connection with one or more embodiments, it is to be understood that the specific mechanisms and techniques which have been described are merely illustrative of the principles of the invention, numerous modifications may be made to the methods and apparatus described without departing from the spirit and scope of the invention as defined by the appended claims.

What is claimed is:

1. A vehicle control system for a frontal ingress and egress vehicle comprising:
at least one vehicle hand control module comprising;
at least one housing, each of said at least one housing is multi-dimensionally position adjustable and has a stowed position and a deployed position;
said at least one housing clear of an entering area of a vehicle control seat when in said stowed position for frontal ingress and egress by a vehicle operator and in a fixed position forward of said vehicle operator, in a seated position, when in said deployed position; and
a plurality of adjustment devices coupled to said at least one housing for mobility control of the vehicle.

2. A system as in claim 1 wherein said at least one vehicle hand control module comprises:
a first hand control module; and
a second hand control module.

3. A system as in claim 2 wherein said first hand control module and said second hand control module are position adjustable to extend laterally forward and at least partially across said vehicle operator.

4. A system as in claim 1 wherein said at least one vehicle hand control module performs as a safety restraint.

5. A system as in claim 1 wherein said vehicle hand control module rotates inward to said deployed state.

6. A system as in claim 1 wherein said at least one housing is coupled to and is 3-dimensionally position adjustable via a plurality of position adjustable elements.

7. A system as in claim 1 wherein said vehicle hand control module is fore and aft position adjustable.

8. A system as in claim 1 wherein said vehicle hand control module is vertically position adjustable.

9. A system as in claim 1 wherein said at least one vehicle hand control module comprises at least one lock for limiting position adjustment thereof in at least one direction.

10. A system as in claim 1 wherein said at least one vehicle hand control module comprises at least one of a throttle control, a vehicle heading control, a gear control, a transmission control, a wheel drive control, and a brake control.

11. A system as in claim 1 wherein said at least one vehicle hand control module comprises at least one non-mobility control.

12. A system as in claim 11 wherein said at least one non-mobility control comprises at least one control selected from an audio control, a video control, a signal indicator control, and a brake control.

13. A system as in claim 1 wherein said at least one vehicle hand control module comprises an indicator.

14. A system as in claim 13 wherein said indicator comprises at least one of a signal indicator, an object indicator, a vehicle system status indicator, a fuel level indicator, a power source supply level indicator, and a display.

15. A system as in claim 1 wherein said at least one vehicle hand control module comprises at least one of a global positioning system and a navigation system.

16. A system as in claim 1 wherein said at least one vehicle hand control module is systematically deployable.

17. A frontal ingress and egress vehicle comprising:
a vehicle operator control station configured for frontal ingress and egress;
at least one hand control module that is at least partially contained within said vehicle operator control station, that is multi-dimensionally position adjustable, and that generates at least one control signal;
a motor; and
a controller coupled to said hand control module and said motor, said controller controlling mobility of the vehicle in response to said at least one control signal via said motor.

18. A vehicle as in claim 17 wherein said at least one hand control module is a drive-by-wire module.

19. A control system for frontal ingress and egress operator station comprising:
at least one hand control module comprising;
at least one housing, each of said at least one housing is multi-dimensionally position adjustable and has a stowed position and a deployed position;
said at least one housing clear of an entering area of a control seat when in said stowed position for frontal ingress and egress by an operator and in a fixed position forward of said operator, in a seated position, when in said deployed position; and
a plurality of instruments coupled to said at least one housing for monitoring, adjusting, and controlling non-mobility related devices.

20. A system as in claim 19 wherein said plurality of instruments comprise at least one simulation task performing instrument.
